(19) United States
(12) Patent Application Publication
(10) Pub. No.: US 2017/0024455 A1
(43) Pub. Date: Jan. 26, 2017

(54) EXPANDING MUTUALLY EXCLUSIVE CLUSTERS OF USERS OF AN ONLINE SYSTEM CLUSTERED BASED ON A SPECIFIED DIMENSION

(71) Applicant: Facebook, Inc., Menlo Park, CA (US)

(72) Inventors: Spencer Powell, San Francisco, CA (US); Boris Pierre Arnoux, Olten (SE); Sue Ann Hong, San Francisco, CA (US); Daniel K. Chapsky, Brooklyn, NY (US); Adam Scott Berger, New York, NY (US); Nikhil Girish Nawathe, New York, NY (US); Christopher William Jones, Mill Valley, CA (US); Justin Thomas Palumbo, Menlo Park, CA (US); Edward R. Gan, Mountain View, CA (US); Rituraj Kirti, Los Altos, CA (US); Mui Thu Tran, San Carlos, CA (US); Yujie Yang, Mountain View, CA (US)

(21) Appl. No.: 14/808,320

(22) Filed: Jul. 24, 2015

(51) Int. Cl. G06F 17/30; H04L 29/08

(52) U.S. Cl. CPC G06F 17/30598; G06F 17/30424; H04L 67/306

(57) ABSTRACT

An online system receives information from an entity identifying a set of users of the online system and groups users included in the set into clusters based on their similarities using a clustering model or algorithm (e.g., k-means clustering) and based on one or more parameters specified by the entity. The online system generates expanded clusters that include additional users in one or more clusters based on similarities between the additional users and users in various clusters. If an additional user is included in multiple expanded clusters, the online assigns the additional user exclusively to an expanded cluster that best fits the user.

### BACKGROUND

This disclosure relates generally to online systems, and more specifically to segmenting groups of online system users.

An online system, such as a social networking system, allows its users to connect to and to communicate with other online system users and with objects on the online system. Users may create profiles on an online system that are tied to their identities and include information about the users, such as interests and demographic information. The users may be individuals or entities such as corporations or charities. Because of the increasing popularity of online systems and the significant amount of user-specific information maintained by online systems, an online system allows users to easily communicate information about themselves to other users and share content with other users. For example, an online system provides content items to a user describing actions performed by other users of the online system who are connected to the user.

Additionally, entities (e.g., a business) sponsor presentation of content items (“sponsored content” or “sponsored content items”) via an online system to gain public attention for the entity's products or services, or to persuade online system users to take an action regarding the entity's products or services. Many online systems receive compensation from an entity for presenting online users with certain types of sponsored content items provided by the entity. Frequently, online systems charge an entity for each presentation of sponsored content to an online system user (e.g., each “impression” of the sponsored content) or for each interaction with sponsored content by an online system user (e.g., each “conversion”). For example, an online system receives compensation from an entity each time a content item provided by the entity is displayed to a user on the online system or each time a user presented with the content item requests additional information about a product or service described by the content item by interacting with the content item (e.g., requests a product information page by interacting with the content item).

An entity may associate targeting criteria with sponsored content items or organic content items to present specific content items to online system users having different characteristics. The online system identifies a content item associated with targeting criteria as eligible for presentation to users having characteristics satisfying at least a threshold number of the targeting criteria and does not present the content item associated with the targeting criteria to users who do not have characteristics satisfying at least the threshold number of the targeting criteria. Targeting criteria may be based on any suitable characteristics of users, such as demographic information associated with users, actions performed by users, connections between users and other users, or interests of users.

Conventional online systems use targeting criteria associated with content items by entities providing the content items or otherwise associated with the content items to specify target audiences of users eligible to be presented with the content items. Hence, if an entity associates targeting criteria with a content item specifying a broad target audience, presentation of the content item by the online system may be less effective in achieving the entity's goals. For example, if a magazine publisher associates targeting criteria identifying users who are at least 18 years old without identifying other characteristics with content items, the magazine publisher is unable to communicate information identifying magazines having specific subject matter to users with interests in different subject matter. This may reduce the number of users who interact with the content items.

While targeting criteria allow presentation of specific content items to various online system users, certain content items may be also relevant to online system users who do not have characteristics matching at least a threshold number of targeting criteria associated with the certain content items. Additionally, an online system may have limited information about characteristics of certain users. This lack of information about certain user may prevent the online system from determining users satisfy at least the threshold number of targeting criteria associated with a content item, which may prevent presentation of the content item to users having an interest in the content item. Hence, an entity may miss opportunities to present an online system user with content relevant to the online system user.

### SUMMARY

An online system receives information from an entity, such as a business entity, identifying a set of users of the online system, which may define a target audience for receiving a communication from the entity. For example, users included in a target audience are identified based on demographic information (e.g., age and gender), connections with the entity (e.g., users who are connected to a page associated with the entity maintained by the online system), and actions performed by the users on the online system (e.g., previous interactions with content maintained by the online system). The online system groups users included in a target audience into clusters based on their similarities using a clustering model or algorithm (e.g., k-means clustering).

To perform the clustering, the online system identifies one or more dimensions along which to cluster the users. In various embodiments, the online system receives information from the entity identifying a dimension (e.g., age, location, interests, etc.) along which to cluster the users. The online system associates a vector with each user in the target audience, where a coordinate of a dimension of the vector is based on a value of an identified dimension associated with a user. For certain dimensions, the online system generates a vector space in which various values of a dimension are defined and associates each user with a vector based on information associated with the user and with the dimension. For example, the online system generates a vector space in which interests are defined and associates each user in the target audience with a vector based on interests associated with each user. Based on the vectors associated with the users in the target audience, the online system generates clusters of users by applying a clustering algorithm to the vectors. For example, a clustering algorithm generates clusters of users based on distances between vectors associated with users in the target audience. The online system may generate a number of clusters specified by the entity or may determine a number of clusters to generate. Additionally, the entity may specify a threshold distance between clusters or other conditions affecting generating of the clusters. In some embodiments, the online system communicates information describing the clusters to the entity, allowing the entity to refine presentation of content to users included in various clusters.

The online system may generate the clusters of users in the target audience based on one or more parameters specified by the entity. For example, the online system clusters users based on one or more particular dimensions specified by the entity or based on a particular number of dimensions specified by the entity. Example dimensions for clustering users include: user profile information (e.g., age, interests, and geographic location), actions performed by the users with content maintained by the online system (e.g., expressing a preference for content having one or more characteristics, installing an application, performing a specific interaction with a specific content item), and actions performed by the users with content external to the online system (e.g., content on a third party system with which the users performed one or more interactions, types of interactions performed by the users with content external to the online system). In one embodiment, the online system generates the clusters of users based solely on dimensions specified by the entity. Alternatively, the online system generates the clusters of users based on dimensions specified by the entity as well as additional dimensions. If the online system generates clusters based on dimensions specified by the entity as well as additional dimensions, the online system differently weight dimensions used for generating the clusters so dimensions specified by the entity have higher weights than other dimensions when generating the clusters.

The online system may provide the entity with a user interface for specifying information (e.g., target audience, dimensions along which to cluster, number of clusters, etc.) to generate the clusters. Based on the information specified by the entity, the online system generates clusters of users and communicates information describing the clusters to the entity. For example, the online system clusters users based on information from the entity via the user interface and subsequently modifies the clusters based on adjustments to the information by the by the entity. Information describing changes to the clusters or describing modified clusters may be communicated to the entity by the online system.

The online system also expands a cluster to include additional users having characteristics matching or similar to characteristics of users in the cluster. Different numbers of clusters may be expanded by the online system in various embodiments. In various embodiments, the online system trains a model based on characteristics of users included in a cluster and applies the trained model to other online system users. Based on application of the model, the online system identifies additional users for inclusion in the cluster. For example, application of the model to characteristics of a user generates a value based on similarity between characteristics of the user and characteristics of users in the cluster; if the value for the user equals or exceeds a threshold value, the online system includes the user in the cluster.

If expanding multiple clusters causes a user to be included in multiple expanded cluster, the online system selects an expanded cluster from the expanded clusters including the user and associates the user exclusively with the selected expanded cluster. When selecting an expanded cluster, the online system determines whether the user was included in a cluster prior to expansion of the cluster. In response to determining the user was included in a cluster prior to expansion of the cluster, the online system associates the user with the cluster that included the user prior to expansion of the cluster. However, if the user was not included in a cluster prior to expansion of the clusters, the online system determines distances between a vector associated with the user and centroids of each expanded cluster including the user and associates the user with an expanded cluster having a centroid with a minimum distance to the vector associated with the user.

Alternatively, the online system determines measures of similarity between the user and users included in an expanded cluster including the user. Based on the measures of similarity between the user and users included in an expanded cluster, the online system determines a measure of similarity between the user and the expanded cluster. For example, the measure of similarity between the user and the expanded cluster is an average of the measures of similarity between the user and users in the expanded cluster. Measures of similarity between the user and various expanded clusters are determined, and the online system associates the user with the expanded cluster with which the user has a maximum measure of similarity.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for generating mutually exclusive expanded clusters of users of online system users, in accordance with an embodiment.

FIG. 4 is an example of clusters of online system users generated based one or more dimensions, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

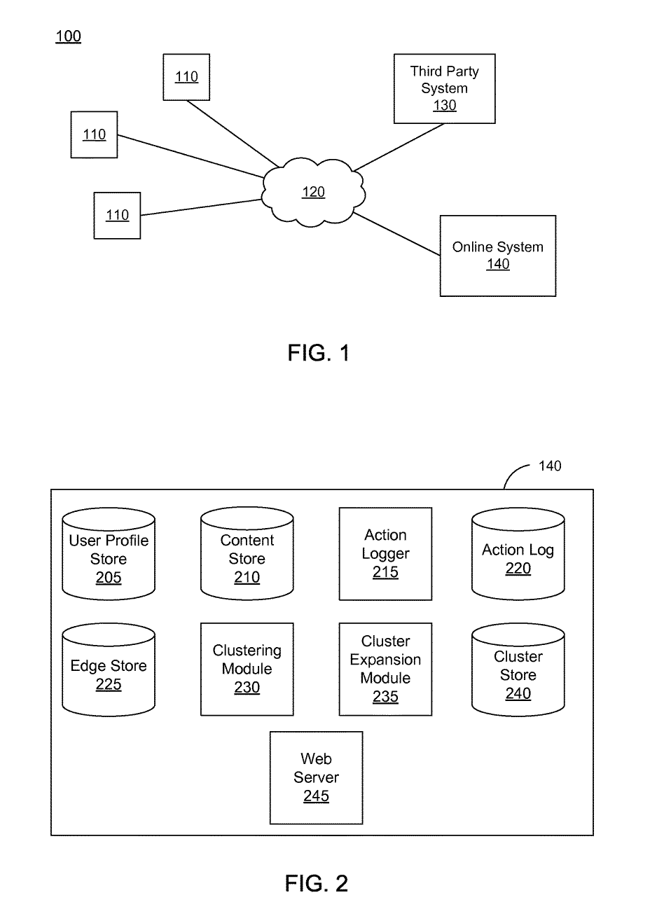

FIG. 1 is a block diagram of a system environment 100 for an online system 140, such as a social networking system. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a clustering module 230, a cluster expansion module 235, a cluster store 240, and a web server 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, interactions with advertisements, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The clustering module 230 generates one or more clusters each including online system users based on similarities between the users. To generate the clusters, the clustering module 230 generates a vector associated with each user in a target audience based on characteristics of the users and includes a user in a cluster based on the distance of one or more dimensions of a vector associated with the user to a mean value associated with a dimension across multiple (e.g., all) vectors. Coordinates of the vector associated with the user are based on values of various dimensions associated with the user; example dimensions include: interest, age, location, actions performed by the user, connections between the user and other users or objects, demographic information associated with the user, or other suitable information associated with the user. For dimensions that use text data, such as interests, the clustering module 230 may apply a word to vector process (e.g., a bag of words process, a skip-gram process, a combination of a bag of words and a skip-gram process, an n-gram process etc.) to the text data to generate a vector describing the non-numeric data. For example, a word to vector process used by the clustering module 230 is a model initially applied to a training set of text data to identify a vocabulary of words and determine vector representations of the words in the vocabulary. The training set of text data may be retrieved from one or more third party systems 130, from data maintained by the online system 140, or from any suitable source. Various training sets of text data may be used in different embodiments to train the model. When the model is applied to text data (e.g., text in the training set), vectors associated with words within a threshold distance of each other or having a specific grammatical relationship with each other are positioned so the vectors have a similar direction in a topic space. In various embodiments, the model applied by the online system 140 uses individual words or groups of words (e.g., groups of two words, groups of three words) to determine a vector corresponding to text data.

Based on distances between vectors associated with users, the clustering module 230 generates clusters of users. For example, users associated with vectors having a value associated with a dimension that is within a specified distance to a mean value associated with the dimension are included in a cluster corresponding to the mean value. In various embodiments, the clustering module 230 generates clusters from a set of users, or a “target audience,” specified to the clustering module 230 by an entity, such as a user or a third party system 130. Hence, a cluster generated by the clustering module 230 includes users form the target audience associated with vectors that are closest to each other based on a clustering algorithm such as k-means clustering. Additionally, the clustering module 230 determines a centroid of each cluster based on vectors associated with users in the cluster. For example, the centroid of a cluster is an average of the vectors associated with users in the cluster. The clustering module 230 may generate a specific number of clusters, until distances between each pair of clusters is less than a threshold distance, or until any suitable condition is satisfied.

Example dimensions for generating clusters include: user profile information (e.g., age, interests, and geographic location) from the user profile store 205, actions performed by the users with content maintained by the online system 140 (e.g., expressing a preference for content having one or more characteristics, installing an application, performing a specific interaction with a specific content item, types of client devices 110 used to perform actions, a frequency with which one or more interactions are performed) from the action log 220, connections between the user and other users objects from the edge store 225, and actions performed by the users with content external to the online system 140 (e.g., content on a third party system 130 with which the users performed one or more interactions, types of interactions performed by the users with content external to the online system 140, durations for which content on a third party system 130 was accessed) from the action log 220. User profile information for generating clusters may include: age, interests, geographic location, educational background, employment history, or other suitable information.

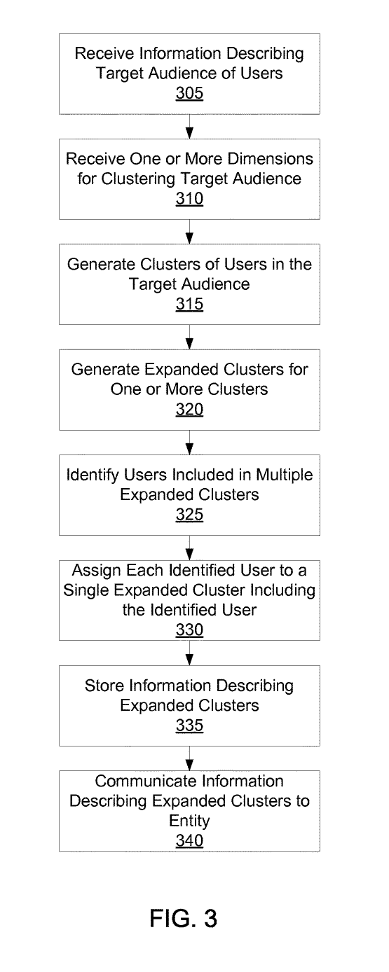

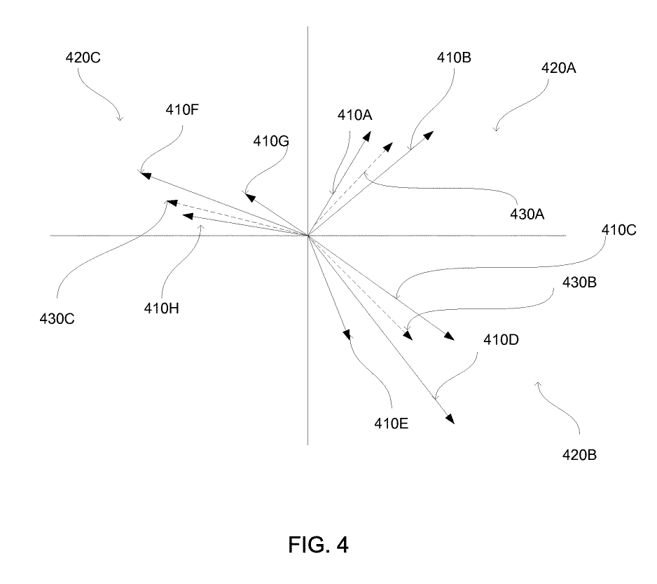

The entity identifying the target audience may also specify one or more parameters for clustering users in the target audience. For example, the entity specifies one or more particular dimensions for clustering the users. As another example, the entity specifies a number of dimensions to use when clustering the users. Additionally, the entity may specify a number of clusters for the clustering module 230 to generate or a threshold distance between centroids of clusters generated by the clustering module 230. In some embodiments, the clustering module 230 generates clusters of users exclusively using dimensions specified by the entity. Alternatively, the clustering module 230 generates clusters of users based on dimensions specified by the entity as well as additional dimensions; the clustering module may associate different weights with different dimensions when generating the clusters and associate higher weights with dimensions specified by the entity than with other dimensions. For example, if an advertiser specifies a dimension of user interests and the clustering module 230 generates clusters the users based on user interest as well as user ages, the clustering module 230 more heavily weights user interest when generating clusters. Generating clusters of users from a target audience is further described below in conjunction with FIGS. 3-4C.

The cluster expansion module 235 expands one or more clusters generated by the clustering module 230 to include additional online system users having characteristics matching or similar to characteristics of users in the one or more clusters. In various embodiments, the cluster expansion module 235 identifies a cluster and trains a model based on characteristics of users included in the cluster. The cluster expansion module 235 applies the trained model to other online system users and identifies additional users for inclusion in an expanded cluster that includes users in the identified cluster as well as the identified additional users. For example, application of the model to characteristics of a user generates a value based on similarity between characteristics of the user and characteristics of users in a cluster; if the value for the user equals or exceeds a threshold value, the online system includes the user in an expanded cluster that includes the users in the cluster. In some embodiments, the cluster expansion module 235 generates a model specific to each generated cluster, with a model specific to a cluster based on demographic information of users in the cluster, actions performed by users in the cluster, or other suitable information associated with users in the cluster.

As an additional example, the cluster expansion module 235 applies a model to a user of the online system who is not in a cluster and to various generated clusters to generate a cluster score between the user and various clusters based at least in part on similarities between characteristics of the user characteristics and characteristics of users in each cluster. If the cluster score between the user and a cluster equals or exceeds a threshold score, the cluster expansion module 235 includes the user in an expanded cluster along with users already included in the cluster including users in the cluster. In various embodiments, the cluster expansion module 235 may vary the threshold score to modify a degree of similarity between a user not included in a cluster and users already included in the cluster for the user to be included in an expanded cluster along with the users already included in the cluster based on a distribution of cluster scores for various users. Identifying additional online system users that are similar to a group of online system users is further described in U.S. patent application Ser. No. 13/297,117, filed on Nov. 15, 2011, and in U.S. patent application Ser. No. 11/290,355, filed on May 29, 2014, each of which is hereby incorporated by reference in its entirety. Additionally, the cluster expansion module 235 determines a centroid of each expanded cluster based on vectors associated with users included in the cluster that was expanded and vectors associated with additional users included in the expanded cluster, as further described above.

If expanding multiple clusters causes a user to be included in multiple expanded clusters, the cluster expansion module 235 selects an expanded cluster from the expanded clusters including the user and associates the user exclusively with the selected expanded cluster. When selecting an expanded cluster to associated with a user included in multiple expanded cluster, the cluster expansion module 235 determines whether the user was included in a cluster prior to expansion of the cluster. In response to determining the user was included in a cluster prior to expansion of the cluster, the cluster expansion module 235 associates the user with the cluster that included the user prior to expansion of the cluster and removes the user from other expanded clusters. However, if the user was not included in a cluster prior to expansion of the clusters, the cluster expansion module 235 determines distances between a vector associated with the user and centroids of each expanded cluster including the user and associates the user with an expanded cluster having a centroid with a minimum distance to the vector associated with the user while removing the user from other expanded clusters. Alternatively, the cluster expansion module 235 determines a measure of similarity between the user and each expanded cluster that includes the user and associates the user with the expanded cluster with which the user has a maximum measure of similarity while removing the user from other expanded clusters. The measure of similarity between the user and an expanded cluster may be based on characteristics of the user and characteristics of users in the expanded cluster. Expansion of clusters and association of users with a single expanded cluster is further described below in conjunction with FIGS. 3 and 4.

The cluster store 240 stores information associated with clusters and expanded clusters from the clustering module 240 and from the cluster expansion module 235, respectively. For example, the cluster store 240 includes an identifier associated with each cluster and associates identifiers of users included in a cluster with the identifier associated with the cluster. Similarly, the cluster store 240 includes identifiers of expanded clusters and associates identifiers of users included in an expanded cluster with an identifier of the expanded cluster. Additionally, the cluster store 240 may associate information identifying an entity for which a cluster or an expanded cluster was generated with an identifier of the cluster or an identifier of the expanded cluster. Additional information describing a cluster or an expanded cluster may also be stored in the cluster store 240 in association with the cluster or with the expanded cluster. For example, the cluster store 240 includes information identifying a target audience specified by an entity, one or more dimensions specified by the entity for generating clusters, information describing characteristics of users in the generated clusters or in the expanded clusters (e.g., percentage of users in a cluster or in an expanded cluster having one or more specified characteristics.), a number of users in each cluster, a number of users in each expanded cluster, a time when clusters or expanded clusters were generated, or any other suitable information associated with clusters or with expanded clusters.

The web server 245 links the online system 140 via the network 120 to the one or more client devices 110, as well as to the one or more third party systems 130. The web server 245 serves web pages, as well as other content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that is stored in the content store 210. Additionally, the web server 245 may provide application programming interface (API) functionality to send data directly to native client device operating systems, such as IOS®, ANDROID™, WEBOS®, or BlackberryOS.

### Generating Mutually Exclusive Expanded Clusters of Online System Users

FIG. 3 is a flowchart of one embodiment of a method for generating mutually exclusive expanded clusters of users of an online system 140. In other embodiments, the method may include different and/or additional steps than those shown in FIG. 3. Additionally, steps of the method may be performed in different orders than the order described in conjunction with FIG. 3 in various embodiments.

The online system 140 receives 305 information from an entity, such as a business, an organization, or a user, describing set of users of the online system 140 targeted by the entity to receive content (i.e., a “target audience”). For example, the online system 140 receives 305 information from an advertiser describing a target audience of users of the online system 140 for receiving one or more advertisements from the advertiser. As an additional example, the online system 140 receives 305 information from a university career center describing a target audience of students at a university for receiving an announcement identifying internship opportunities.

The information describing the target audience may be targeting criteria, so the target audience includes users of the online system 140 having characteristics matching or satisfying at least a threshold number or a threshold percentage of the targeting criteria. For example, targeting criteria describing the target audience identify an action of accessing content associated with the entity within a threshold time from a current time, so online system users who have accessed the identified content within the threshold time from the current time form the target audience. As another example, targeting criteria identify users who are females between the ages of 18 and 45 and who have expressed an interest in fashion as a target audience for receiving content from the entity. As described above in conjunction with FIG. 2, targeting criteria describing the target audience may include: user profile information associated with online system users (e.g., demographic information, interests), actions between online system users and content provided by the online system 140, actions between online system users and content provided by third party systems 130, and connections between online system users.

Additionally, the online system 140 receives 310 one or more dimensions for generating clusters of users in the target audience. A dimension corresponds to characteristics associated with users or other information associated with users. Example dimensions include: interests, geographic locations, other demographic information, actions performed by users with content presented by the online system 140, actions performed by users with content presented by third party systems 130, connections between users and objects or other users of the online system 140, or any other suitable information. One or dimensions may be more specific than targeting criteria used to describe the target audience. For example, if targeting criteria specifies a country for a location, one or more dimensions may identify time zones within the country or states within the country. In some embodiments, the online system 140 receives 310 information describing the dimensions from the entity that provided the information describing the target audience to the online system 140. For example, the online system 140 receives 310 a request from the entity to generate clusters of users in the target audience based on the users' ages and interests, a frequency with which users have accessed the online system 140 via a mobile device, and a time of day during which users provided content to the online system 140. As an additional example, the online system 140 receives 310 a request from the entity to cluster the target audience based on monetary amounts of purchases made by users on third party systems 130 that identify users of the online system 140 and communicate information to the online system 140.

In addition to the one or more dimensions, the online system 140 may also receive one or more parameters from the entity describing generation of clusters of users in the target audience. For example, the entity specifies a number of dimensions for the online system 140 to generate clusters of users. As an additional example, the entity specifies a number of clusters to generate, a threshold distance between pairs of clusters, or other conditions that halt generation of clusters when satisfied.

The online system 140 generates 315 clusters of users in the target audience based at least in part on the received one or more dimensions by applying a clustering algorithm to users in the target audience. For example, the online system 140 quantifies the one or more dimensions associated with each user in the target audience in a vector space, so each user in the target audience is associated with a vector. For example, to cluster users based on number of times users provided content to a page maintained by the online system 140 within 30 days of a current date, the online system 140 associates a vector with each user in the target audience, with a coordinate of the vector associated with a user based on the number of times the user provided content to the page maintained by the online system 140 within 30 days of the current date. The online system 140 applies a clustering algorithm (e.g., k-means algorithm or any other suitable algorithm) to the vectors associated with users in the target audience to generate 315 clusters of users based on the one or more dimensions. As described above in conjunction with FIG. 2, for dimensions that use textual data, such as interests, the online system 140 may apply a word to vector process (e.g., a bag of words process, a skip-gram process, a combination of a bag of words and a skip-gram process, an n-gram process etc.) to the text data to generate a vector describing the non-numeric data and generate 315 clusters based on the generated vectors.

Clustering algorithms applied to vectors associated with users in the target audience by the online system 140 generate 315 clusters of users that are groups of users from the target audience associated with vectors that are closest to each other. For example, users associated with vectors having a value associated with a dimension that is within a specified distance to a mean value associated with the dimension are included in a cluster corresponding to the mean value. In other embodiments, a cluster generated 315 by the online system 140 includes users form the target audience associated with vectors that are closest to each other based on a clustering algorithm, such as k-means clustering or any other suitable clustering algorithm. Additionally, the online system 140 determines a centroid of each cluster based on vectors associated with users in the cluster. For example, the centroid of a cluster is an average of the vectors associated with users in the cluster. The online system 140 may generate 315 a specific number of clusters, generate 315 clusters until distances between each pair of clusters is less than a threshold distance, or generate 315 clusters until any suitable condition is satisfied.

FIG. 4 shows an example of clusters of users generated 315 by the online system 140 based on one or more dimensions. Each vector 410A-410H (also referred to individually and collectively using reference number 410) in FIG. 4 has coordinates based on values of one or more dimensions associated with different users in the target audience. For example, if dimensions of interests, and geographic location are received by the online system 140, the online system 140 generates vectors associated with each user in the target audience based on values for interests and geographic location associated with the different users in the target audience. In the example of FIG. 4, based on the vectors associated with the users, the online system generates three clusters 420A, 420B, 420C (also referred to individually and collectively using reference number 420) based on the distances between the vectors 410A-410H associated with the users. For example, cluster 420A includes users associated with vector 410A and vector 410B, which are separated by a shorter distance than distances between vector 410A or vector 410B and other vectors 410C-410H. Also based on distances between vectors 410, cluster 420B includes users associated with vectors 410C, 410D, and 410E, and cluster 420C includes users associated with vectors 410F, 410G, 410H. Based on the vectors included in each cluster 420, the online system 140 generates centroids for each cluster 420. FIG. 4 shows centroid 430A for cluster 420A, centroid 430B for cluster 420B, and centroid 430C for cluster 420C.

Referring to FIG. 3, the online system 140 applies the clustering algorithm to the centroids of each cluster and generates further clusters by combining clusters based on distances between centroids of the clusters until one or more criteria are satisfied. For example, vectors and clusters are iteratively grouped into additional clusters until a specified number of clusters are generated 315 or distances between centroids of generated clusters are less than a threshold distance. Conditions that when satisfied halt generation 315 of clusters may be received from the entity, as further described above in conjunction with FIG. 2.

When one or more dimensions used to generate 315 the clusters are received 310 from the entity, in some embodiments, the online system 140 generates 315 the clusters using only the dimensions received 310 from the entity. In other embodiments, the online system 140 generates 315 the clusters using the dimensions received 310 from the entity as well as additional dimensions, but associates weights with the one or more dimensions received 310 from the entity so the one or more dimensions received 310 from the entity have a greater influence on cluster generation. For example, if an advertiser specifies certain interactions with an advertisement as a dimension for clustering users in the target audience, the online system 140 generates 315 clusters from vectors based on the certain interactions as well as geographic locations associated with users, where the certain interactions are associated with a scaling factor to increase their contribution to the vectors used to generate 315 the clusters.

Information describing the clusters may be stored by the online system 140. For example, the online system 140 stores an identifier of the entity from which information describing the target audience was received 305, dimensions used to generate 315 clusters, identifiers associated with each identified clusters, and user identifiers in association with identifiers associated with clusters including various users. Additional information describing the clusters may be stored in other embodiments.

The online system 140 generates 320 expanded clusters for each of a set of the generated clusters. An expanded cluster includes users grouped into a cluster as well as one or more additional users. To expand a cluster, the online system 140 trains a model based on characteristics of users included in the cluster and applies the trained model to other online system users who are not in the cluster. Based on application of the trained model to characteristics of the other online system users, the online system 140 identifies additional users to include in an expanded cluster having users in the cluster as well as the identified additional users. For example, application of a model trained based on characteristics of users in a cluster to characteristics of an additional user generates a value based on similarity between characteristics of the additional user and characteristics of users in a cluster. If the value for the additional user equals or exceeds a threshold value, the online system 140 includes the user in an expanded cluster that includes the users in the cluster and additional users having values equaling or exceeding the threshold value. In some embodiments, the online system 140 generates a model specific to each generated cluster, with a model specific to a cluster based on demographic information of users in the cluster, actions performed by users in the cluster, or other suitable information associated with users in the cluster. Alternatively, the online system 140 generates models specific to various clusters in a set of the generated clusters.

As an additional example, the online system 140 applies a model to a user of the online system who is not in a cluster and to various generated clusters to generate a cluster score between the user and various clusters based at least in part on similarities between characteristics of the user characteristics and characteristics of users in each cluster. If the cluster score between the user and a cluster equals or exceeds a threshold score, the online system 140 includes the user in an expanded cluster along with users already included in the cluster including users in the cluster. In various embodiments, the online system 140 may vary the threshold score to modify a degree of similarity between a user not included in a cluster and users already included in the cluster for the user to be included in an expanded cluster along with the users already included in the cluster based on a distribution of cluster scores for various users. Identifying additional online system users that are similar to a group of online system users is further described in U.S. patent application Ser. No. 13/977,117, filed on Nov. 15, 2011, and in U.S. patent application Ser. No. 14/290,355, filed on May 29, 2014, each of which is hereby incorporated by reference in its entirety. The online system 140 also determines a centroid of each expanded cluster based on vectors associated with users included in the cluster and vectors associated with additional users included in the expanded cluster along with the users included in the cluster, as further described above.

The online system 140 identifies 325 one or more users who are included in multiple expanded clusters and assigns 330 each user included in multiple expanded clusters to an expanded cluster. Hence, for a user included in multiple expanded clusters, the online system 140 assigns the user to a single expanded cluster that includes the user. This causes each user included in an expanded cluster to be assigned 330 to a single expanded cluster. To assign 330 a user included in multiple expanded clusters to a single expanded cluster, the online system 140 initially determines whether the user was included in a cluster prior to generating an expanded cluster based on the users in the cluster. In response to determining the user was included in a cluster prior to generating an expanded cluster from the cluster, the online system 140 assigns 330 the user to the cluster that included the user prior to generation of the expanded cluster from the cluster and removes the user from other expanded clusters including the user. However, if the user included in multiple expanded clusters was not included in a cluster prior to generation of expanded clusters from the clusters, the online system 140 determines distances between a vector associated with the user and centroids of each expanded cluster including the user and assigns 330 the user to an expanded cluster having a centroid with a minimum distance to the vector associated with the user and removes the user from other expanded clusters that included the user. When the user is removed from the other expanded clusters, the online system 140 updates the centroids associated with each of the other expanded clusters to account for the removal of the user from the other expanded clusters.

In other embodiments, the online system 140 determines a measure of similarity between a user included in multiple expanded clusters and each expanded cluster including the user and assigns 330 the user to an expanded cluster with which the user has a maximum measure of similarity while removing the user from the other expanded clusters. A measure of similarity between the user and an expanded cluster may be based on characteristics of the user and characteristics of users in the expanded cluster. For example, a greater number of characteristics of the user matching characteristics of users in an expanded cluster causes the user to have a larger measure of similarity to the expanded cluster. The similarity score between the user and an expanded cluster may be based solely on characteristics corresponding to dimensions used to generate 315 the clusters or may be based on characteristics corresponding to dimensions used to generate 315 the clusters as well as characteristics corresponding to additional dimensions. Various weights may be associated with characteristics of the user and the users included in an expanded group, with larger weights associated with characteristics corresponding to dimensions used to generate 315 the clusters in some embodiments. As described above, the online system 140 modifies the centroids of expanded clusters from which the user was removed.

The online system 140 updates information describing the expanded clusters after assigning 330 each user included in multiple expanded clusters to a single expanded cluster and stores 335 the updated information. Information describing the updated expanded clusters includes identifiers of users included in an updated expanded cluster associated with an identifier of the updated expanded cluster. Additionally, information describing the updated expanded cluster may identify dimensions used to generate 315 the cluster from which the expanded cluster was generated 320, the entity that identified the target audience, or other suitable information. In some embodiments, the online system 140 stores 335 information describing characteristics of users in an updated expanded cluster in association with the expanded cluster (e.g., percentages of male or female users in the updated expanded cluster, an age range of users included in the updated expanded cluster). In some embodiments, the online system 140 communicate 340 information describing the updated expanded clusters to the entity, allowing the entity to create content tailored for presentation to users in different updated expanded clusters or to refine targeting criteria to more particularly identify users to receive content (e.g., specify targeting criteria based on characteristics of users in various expanded clusters).

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at an online system, a target audience from an entity, the target audience identifying a set of users of the online system;
receiving a dimension along which to cluster the users in the target audience;
generating a plurality of clusters of users in the target audience by applying a clustering algorithm to characteristics of users in the target audience to group each of the users of the target audience into one of the plurality of clusters based at least in part on the received dimension;
for each of a set of the clusters, expanding the cluster by adding one or more users to the cluster based on one or more similarities between the users in the cluster and the users added to the cluster;
identifying one or more added users in one or more of the expanded clusters who are included in in multiple expanded clusters;
updating the plurality of clusters by assigning the identified added users to a single expanded cluster; and
storing information describing the updated plurality of clusters.

2. The method of claim 1, further comprising:
communicating at least a subset of the information describing the updated plurality of clusters to the entity.

3. The method of claim 1, wherein generating the plurality of clusters of users in the target audience comprises:
determining a vector associated with each user in the target audience, a coordinate of the vector based at least in part on the received dimension; and
generating the plurality of clusters based at least in part on distances between vectors associated with users in the target audience.

4. The method of claim 3, wherein generating the plurality of clusters based at least in part on distances between vectors associated with users in the target audience comprises:
including users associated with vectors having shortest distances between vectors associated with the users in a cluster.

5. The method of claim 3, wherein generating the plurality of clusters is subject to one or more conditions.

6. The method of claim 5, wherein a condition comprises a specified number of clusters.

7. The method of claim 5, wherein the one or more conditions are specified by the entity.

8. The method of claim 1, wherein the dimension along which to cluster users in the target audience is selected from a group consisting of: user profile information associated with users by the online system, actions performed by users with content presented by the online system, actions performed by users with content presented by third party systems, connections between users and objects or other users of the online system, and any combination thereof.

9. The method of claim 1, wherein updating the plurality of clusters by assigning the identified added users to a single expanded cluster comprises:
selecting an identified added user;
determining whether the selected identified added user was included in a cluster of the plurality of clusters; and
responsive to determining the selected identified added user was included in the cluster of the plurality of clusters, assigning the selected identified added user to an expanded cluster generated from the cluster and removing the selected identified added user from other expanded clusters including the selected identified added user.

10. The method of claim 1, wherein updating the plurality of clusters by assigning the identified added users to a single expanded cluster further comprises:
selecting an identified added user;
determining whether the selected identified added user was included in at least one cluster of the plurality of clusters;
responsive to determining the selected identified added user was not included in at least one cluster of the plurality of clusters, determining distances between a vector associated with the selected identified added user and centroids associated with each expanded cluster including the selected identified added user, a centroid associated with an expanded cluster including the selected identified added user based at least in part on vectors associated with users included in the expanded cluster; and
assigning the selected identified added user to an expanded cluster associated with a vector having a minimum distance to the vector associated with the selected identified additional users and removing the selected identified added user from other expanded clusters including the selected identified added user.

11. The method of claim 1, wherein updating the plurality of clusters by assigning the identified added users to a single expanded cluster comprises:
selecting an identified added user;
generating measures of similarity between the selected identified added user and each expanded cluster including the selected identified added user, a measure of similarity between the selected identified added user and an expanded cluster based at least in part on characteristics of the selected identified added user and characteristics of users included in the expanded cluster; and
assigning the selected identified added user to an expanded cluster with which the selected identified user has a maximum measure of similarity and removing the selected identified added user from other expanded clusters including the selected identified added user.

12. A computer program product comprising a computer-readable storage medium having instructions encoded thereon that, when executed by a processor, cause the processor to:
receive, at an online system, a target audience from an entity, the target audience identifying a set of users of the online system;
receive a dimension along which to cluster the users in the target audience;
generate a plurality of clusters of users in the target audience by applying a clustering algorithm to characteristics of users in the target audience to group each of the users of the target audience into one of the plurality of clusters based at least in part on the received dimension;
for each of a set of the clusters, expand the cluster by adding one or more users to the cluster based on one or more similarities between the users in the cluster and the users added to the cluster;
identify one or more added users in one or more of the expanded clusters who are included in in multiple expanded clusters;
update the plurality of clusters by assigning the identified added users to a single expanded cluster; and
store information describing the updated plurality of clusters.

13. The computer program product of claim 12, wherein the computer readable storage medium further has instructions encoded thereon that, when executed by the processor, cause the processor to:
communicate at least a subset of the information describing the updated plurality of clusters to the entity.

14. The computer program product of claim 12, wherein generate the plurality of clusters of users in the target audience comprises:
determine a vector associated with each user in the target audience, a coordinate of the vector based at least in part on the received dimension; and
generate the plurality of clusters based at least in part on distances between vectors associated with users in the target audience.

15. The computer program product of claim 14, wherein generate the plurality of clusters based at least in part on distances between vectors associated with users in the target audience comprises:
include users associated with vectors having shortest distances between vectors associated with the users in a cluster.

16. The computer program product of claim 14, wherein generate the plurality of clusters is subject to one or more conditions.

17. The computer program product of claim 12, wherein the dimension along which to cluster users in the target audience is selected from a group consisting of: user profile information associated with users by the online system, actions performed by users with content presented by the online system, actions performed by users with content presented by third party systems, connections between users and objects or other users of the online system, and any combination thereof.

18. The computer program product of claim 12, wherein update the plurality of clusters by assigning the identified added users to a single expanded cluster comprises:
select an identified added user;
determine whether the selected identified added user was included in a cluster of the plurality of clusters; and
responsive to determining the selected identified added user was included in the cluster of the plurality of clusters, assign the selected identified added user to an expanded cluster generated from the cluster and remove the selected identified added user from other expanded clusters including the selected identified added user.

19. The computer program product of claim 12, wherein update the plurality of clusters by assigning the identified added users to a single expanded cluster further comprises:
select an identified added user;
determine whether the selected identified added user was included in at least one cluster of the plurality of clusters;
responsive to determining the selected identified added user was not included in at least one cluster of the plurality of clusters, determine distances between a vector associated with the selected identified added user and centroids associated with each expanded cluster including the selected identified added user, a centroid associated with an expanded cluster including the selected identified added user based at least in part on vectors associated with users included in the expanded cluster; and
assign the selected identified added user to an expanded cluster associated with a vector having a minimum distance to the vector associated with the selected identified additional users and remove the selected identified added user from other expanded clusters including the selected identified added user.

20. The computer program product of claim 12, wherein update the plurality of clusters by assigning the identified added users to a single expanded cluster comprises:
select an identified added user;
generate measures of similarity between the selected identified added user and each expanded cluster including the selected identified added user, a measure of similarity between the selected identified added user and an expanded cluster based at least in part on characteristics of the selected identified added user and characteristics of users included in the expanded cluster; and
assign the selected identified added user to an expanded cluster with which the selected identified user has a maximum measure of similarity and remove the selected identified added user from other expanded clusters including the selected identified added user.
